(19) United States
(12) Patent Application Publication
(10) Pub. No.: US 2026/0084526 A1
(43) Pub. Date: Mar. 26, 2026

(54) HAPTIC TOUCH PANEL DISPLAY

(71) Applicant: Sharp Display Technology Corporation, Kameyama City (JP)

(72) Inventors: Shugo KANO, Kameyama City (JP); Ryuzo YUKI, Kameyama City (JP); Tomohiro KIMURA, Kameyama City (JP); Naru USUKURA, Kameyama City (JP); Yasuhiro SUGITA, Kameyama City (JP)

(21) Appl. No.: 19/335,791

(22) Filed: Sep. 22, 2025

(30) Foreign Application Priority Data
Sep. 26, 2024 (JP) 2024-167939

(51) Int. Cl. B60K 35/25; B60K 35/22; G02F 1/1333; G06F 3/01

(52) U.S. Cl. CPC B60K 35/25; B60K 35/22; G02F 1/13338; G06F 3/016; B60K 2360/1434

(57) ABSTRACT

A haptic touch panel display includes a display panel including a display region, a touch panel disposed, in the display region, on an upper surface of the display panel or in the display panel, a plurality of actuators configured to vibrate the display panel, a light-transmitting decorative film supported in the display region of the display panel, a haptic control circuit configured to drive the plurality of actuators and thus cause at least a part of the light-transmitting decorative film to vibrate with a first texture represented by an exterior of the light-transmitting decorative film, and a control device configured to control the display panel, the touch panel, and the haptic control circuit.

### CROSS-REFERENCE TO RELATED APPLICATIONS

This application claims the benefit of priority to Japanese Patent Application Number 2024-167939 filed on Sep. 26, 2024. The entire contents of the above-identified application are hereby incorporated by reference.

### BACKGROUND

### Technical Field

The disclosure relates to a haptic touch panel display.

In order to provide users with good operability, touch panel displays having a haptic feedback function have been developed. For example, WO 2011/158585 discloses a display device with a haptic feedback function that can provide satisfactory visual and haptic sensations.

### SUMMARY

Such a touch panel display having a haptic feedback function is used for various applications, and excellent designability is required depending on the form of use in some cases. An object of the disclosure is to provide a haptic touch panel display having excellent designability when the display displays black.

According to an embodiment of the disclosure, there is provided a haptic touch panel display including a display panel including a display region, a touch panel disposed, in the display region, on an upper surface of the display panel or in the display panel, a plurality of actuators configured to vibrate the display panel, a light-transmitting decorative film supported in the display region of the display panel, a haptic control circuit configured to drive the plurality of actuators and thus cause at least a part of the light-transmitting decorative film to vibrate with a first texture represented by an exterior of the light-transmitting decorative film, and a control device configured to control the display panel, the touch panel, and the haptic control circuit.

According to an embodiment of the disclosure, the light-transmitting decorative film having a predetermined design is disposed in the display region of the display panel, and thus the predetermined design appears on the exterior of the display region of the display panel in a state where the haptic touch panel display displays black. Accordingly, the haptic touch panel display capable of harmonizing with a surrounding interior design is provided.

### BRIEF DESCRIPTION OF DRAWINGS

The disclosure will be described with reference to the accompanying drawings, wherein like numbers reference like elements.

FIG. 1 is a schematic view illustrating an instrument panel of a vehicle on which a haptic touch panel display of a first embodiment is mounted.

FIG. 2A is a schematic view illustrating an exterior of the haptic touch panel display in a non-operating state.

FIG. 2B is a schematic view illustrating an exterior of the haptic touch panel display in an operating state.

FIG. 3 is a schematic plan view of the haptic touch panel display.

FIG. 4 is a schematic cross-sectional view of the haptic touch panel display.

FIG. 5 is a block diagram illustrating a configuration of the haptic touch panel display.

FIG. 6 is a flowchart depicting control of the haptic touch panel display in a first display mode.

FIG. 7 is a flowchart depicting control of the haptic touch panel display in the first display mode.

FIG. 8A illustrates an example of image data in the first display mode.

FIG. 8B illustrates an example of a display exterior in the first display mode.

FIG. 9 is a flowchart depicting control of the haptic touch panel display in a second display mode.

FIG. 10 is a flowchart depicting control of the haptic touch panel display in the second display mode.

FIG. 11A illustrates an example of image data in the second display mode.

FIG. 11B illustrates an example of the display exterior in the second display mode.

FIG. 12 illustrates an example of an application region in the second display mode.

FIG. 13 is a flowchart depicting control of the haptic touch panel display for presenting another haptic effect.

FIG. 14 is a flowchart depicting control of the haptic touch panel display for presenting still another haptic effect.

FIG. 15 is a flowchart depicting control of the haptic touch panel display for presenting still another haptic effect.

FIG. 16 is a schematic cross-sectional view of a haptic touch panel display according to a second embodiment.

FIG. 17 is a schematic cross-sectional view of a haptic touch panel display according to a third embodiment.

### DESCRIPTION OF EMBODIMENTS

Embodiments of the disclosure will be described below with reference to the drawings. The disclosure is not limited to the following embodiments, and appropriate design changes can be made within a scope that satisfies the configuration of the disclosure. Further, in the description below, the same reference signs may be used in common among the different drawings for the same portions or portions having the same or similar functions, and descriptions of repetitions thereof may be omitted. Further, the configurations described in the embodiments and the modified examples may be combined or modified as appropriate within a range that does not depart from the gist of the disclosure. For ease of explanation, in the drawings referenced below, configurations may be simplified or schematically illustrated, or a portion of the components may be omitted. Further, dimensional ratios between components illustrated in the drawings are not necessarily indicative of actual dimensional ratios.

The haptic touch panel display of the present embodiment is excellent in designability and operability, and is suitably used as, for example, an information display terminal disposed in an instrument panel of an automobile, a display device or an input device disposed on a wall surface in a room, a display device or an input device disposed in furniture or a household electrical appliance, or the like, for which a luxury feeling is required. Hereinafter, the present embodiment will be described by taking an information terminal disposed in or on an instrument panel of a vehicle as an example.

### First Embodiment

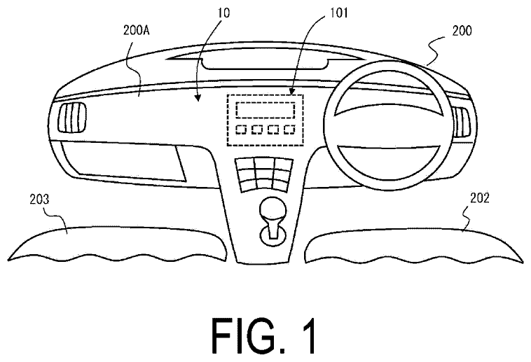

FIG. 1 is a schematic view illustrating an instrument panel 200 of a vehicle on which a haptic touch panel display 101 of the present embodiment is mounted. The instrument panel 200 is located at the front of the interior of the vehicle. In the disclosure, haptic feedback refers to a technique of providing a haptic sensation by providing a force, a vibration, a motion, or the like to an operator.

The haptic touch panel display 101 is disposed, for example, at the center of the instrument panel 200. In the present embodiment, the haptic touch panel display 101 is an information display terminal, and can display various types of information of the vehicle, an operation screen for the vehicle, a surrounding image captured by an in-vehicle camera, a map and traffic information, and an operation screen that are used in a car navigation system, an application screen using various types of information that can be acquired through the Internet line, and the like.

The instrument panel 200 is disposed in front of a driver's seat 202 and a front passenger seat 203. The instrument panel 200 includes, for example, a main panel 200A disposed from a space in front of the driver's seat 202 to a space in front of the front passenger seat 203. The light-transmitting decorative film 10 is disposed on a surface of the main panel 200A as a whole. The light-transmitting decorative film 10 has a predetermined design that appears on the exterior. The predetermined design is, for example, a surface pattern of a material or a finish mark of a material, such as wood grain, or a finish mark of metal treated with a hairline finish or a mirror finish. When the haptic touch panel display 101 is used for applications other than a vehicle, the predetermined design may be a surface pattern of a material or a finish mark of a material, such as concrete, fabric, paper, or a soil wall. In the present embodiment, the light-transmitting decorative film 10 has a design of wood grain.

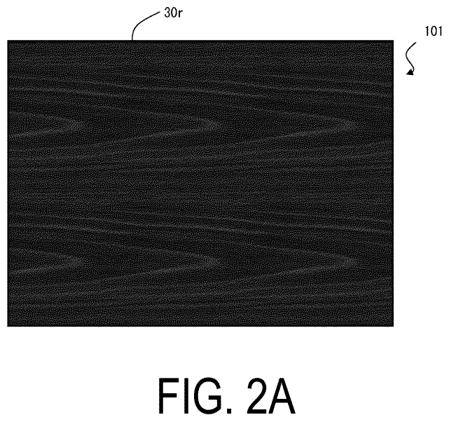

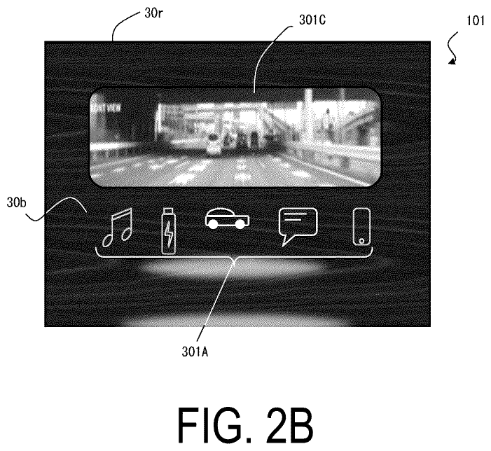

FIG. 2A illustrates an exterior in a case where the haptic touch panel display 101 displays black in the entire display region, and FIG. 2B is a schematic view illustrating a state in which the haptic touch panel display 101 is operating and displaying an image other than the black display. The black display is a display in which a gray scale value of each pixel is zero or a low gray scale value equal to or less than a predetermined value. For example, when the gray scale value is represented by 8 bits (0 to 255), the predetermined value is a gray scale value of 10 or less. The black display is typically presented in an OFF state in which the haptic touch panel display 101 is not operated or in a standby state in which an image is not displayed. Alternatively, the haptic touch panel display 101 may be operating and display an image in which the entire display region is displayed in black, thereby presenting the operator with the black display.

As illustrated in FIG. 2A, when the haptic touch panel display 101 displays black in the entire display region, only the wood grain pattern appears on the exterior of the haptic touch panel display 101. The wood grain pattern is continuous over the entire main panel 200A. Thus, the screen does not appear on the exterior, and thus the instrument panel 200 can present an excellent exterior without drawing attention to the presence of the haptic touch panel display 101.

On the other hand, as illustrated in FIG. 2B, when the haptic touch panel display 101 is operating, for example, a content image 301C and an icon image 301A are displayed in a display region 30r, and only the wood grain pattern is displayed in a background region 30b around the content image and the icon image, as in the case where the haptic touch panel display 101 is not operating.

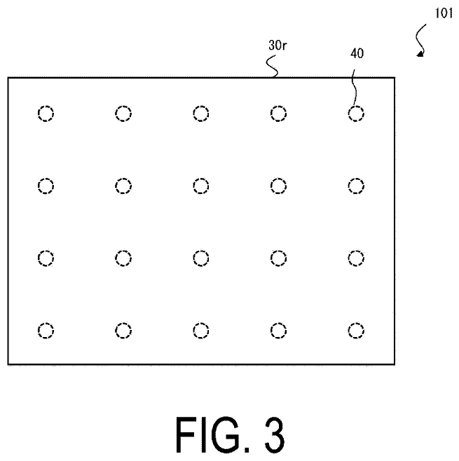

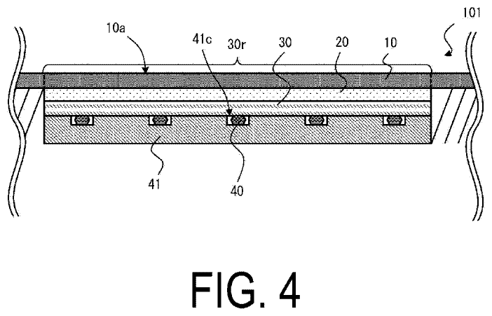

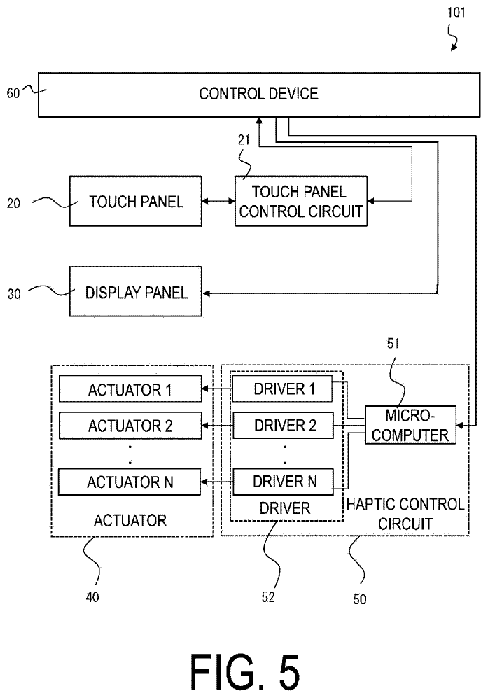

FIG. 3 is a schematic plan view of the haptic touch panel display 101, and FIG. 4 is a schematic cross-sectional view of the haptic touch panel display 101. FIG. 5 is a block diagram illustrating a configuration of the haptic touch panel display 101.

The haptic touch panel display 101 includes a display panel 30, a touch panel 20, a touch panel control circuit 21, a light-transmitting decorative film 10, a plurality of actuators 40, a haptic control circuit 50, and a control device 60.

The display panel 30 is, for example, a liquid crystal display, and a driving method thereof is not particularly limited. The size of the display panel 30 is not particularly limited, either, and may be determined according to the application. The display panel 30 includes the display region 30r, and can display any pixel in the display region 30r with a brightness gray scale value from the lowest value (0) to the highest value (for example, 255 in an 8-bit gray scale value).

In the present embodiment, since the haptic touch panel display 101 is disposed in the instrument panel 200, the size of the display panel 30 is, for example, 6 inches or more and 15 inches or less. As will be described below, in order to efficiently vibrate the display panel 30 by the actuators 40, the thickness of the display panel 30 is preferably small.

The touch panel 20 is disposed on an upper surface of the display panel 30 in the form illustrated in FIG. 4. The touch panel 20 detects a position touched by a finger, a touch pen, or the like in the display region 30r of the haptic touch panel display 101. The touch panel 20 may be any of various types of touch panels such as capacitive, resistive, ultrasonic surface acoustic wave, and infrared touch panels. The touch panel 20 may be disposed at the display panel 30 in any one of an in-cell system, an on-cell system, and an out-cell system. That is, a part or the entirety of the touch panel 20 may be disposed on the upper surface of the display panel 30, or a part or the entirety of the touch panel 20 may be disposed in the display panel 30.

In addition, the touch panel 20 may be a touch panel that detects a position and the magnitude of a pressing force. The touch panel 20 includes, for example, a driving electrode, a position sensing electrode, and a pressing sensing electrode, applies a driving signal to the driving electrode, detects a change in capacitance caused by contact of a finger or the like using the position sensing electrode, and detects a change in capacitance caused by the pressing force of a finger or the like using the pressing sensing electrode. Such a touch panel 20 is disclosed in, for example, JP 2021-128511 A. The disclosure of JP 2021-128511 A is incorporated herein by reference.

As described above, the light-transmitting decorative film 10 has a design of a surface pattern of a material or a finish mark of a material, such as a wood grain or a finish mark of metal treated with a hairline finish. These designs are printed on the surface of the light-transmitting decorative film 10, or are formed inside the light-transmitting decorative film 10 by layering a protection film on the film on which the design is printed, for example. Such a light-transmitting decorative film 10 is commercially available and can be commercially used.

In the present embodiment, at least an upper surface 10a in the display region 30r of the light-transmitting decorative film 10 does not have unevenness, and the upper surface 10a is flat. Since the upper surface 10a does not have unevenness, light emitted from the display panel 30 is scattered at the upper surface 10a, and blurring of an image displayed by the display panel 30 is suppressed.

The light-transmitting decorative film 10 is made of, for example, resin, and transmits visible light. In the region through which strong visible light is transmitted, the image formed by the visible light is visually recognized from the outside, and the design is less likely to be visually recognized.

The plurality of actuators 40 are drive bodies that present a haptic sensation in the haptic touch panel display 101. The actuator 40 is disposed immediately below the display panel 30, that is, at a position overlapping the display panel 30 in a plan view, and vibrates the haptic touch panel display 101.

The actuator 40 is an element that converts electrical energy into mechanical energy by electromechanical conversion, and is specifically a piezoelectric element. For example, one side of a vibration surface of the actuator 40 is preferably approximately 9 mm to 30 mm, and the actuator 40 preferably vibrates at several tens to several hundreds of Hz by applying an AC voltage of approximately 10 V to 100 V.

The plurality of actuators 40 are supported by a support body 41. For example, the support body 41 includes a plurality of storage spaces 41c, and the plurality of actuators 40 correspond to and are disposed in the plurality of storage spaces 41c. The support body 41 is disposed on the display panel 30 such that the actuators 40 in the storage spaces 41c are in contact with the display panel 30. For example, in the present embodiment, the actuators 40 are disposed in four rows and five columns in the display region 30r of the display panel 30.

The control device 60 includes a host computer, and controls the touch panel 20, the display panel 30, and the actuators 40. Specifically, the control device 60 receives display image data to be displayed on the display panel 30 from the outside, and outputs the display image data to the display panel 30.

The touch panel control circuit 21 periodically outputs a driving signal to the electrode of the touch panel 20 and receives a detection signal from the touch panel 20 in order to detect a touch on the display region 30r by the operator. Further, the touch panel control circuit 21 outputs the detection signal to the control device 60 at a predetermined cycle.

The haptic control circuit 50 includes a microcomputer 51 and drivers 52 of a number corresponding to the number of actuators 40 in order to drive the actuators 40. The microcomputer 51 receives, from the control device 60, position information indicating a region of the display region 30r in which the light-transmitting decorative film is to be vibrated and texture information indicating what texture to be given to the operator, for example, and controls the drivers 52 such that the plurality of actuators 40 vibrate according to the position information and the texture information.

The microcomputer 51 controls the drivers 52 such that a predetermined region of the light-transmitting decorative film 10 vibrates with a texture (first texture) represented by a predetermined design that the light-transmitting decorative film 10 has and a texture (second texture) different from the first texture. The “texture” may be used in various meanings. However, the “texture” is mainly used as a term meaning a touch or a tactile sensation in the disclosure.

In the present embodiment, since an example of the predetermined design is wood grain, the microcomputer 51 controls the drivers 52 to vibrate the actuators 40 such that the operator feels the touch of wood grain (first texture) when the operator touches the light-transmitting decorative film 10 with his/her finger. Further, in the region where the icons and the like are displayed, the microcomputer 51 controls the drivers 52 to vibrate the actuators 40 such that the operator feels a touch (second texture) different from that of the wood grain when the operator touches the light-transmitting decorative film 10 with his/her finger.

### (1) First Display Mode

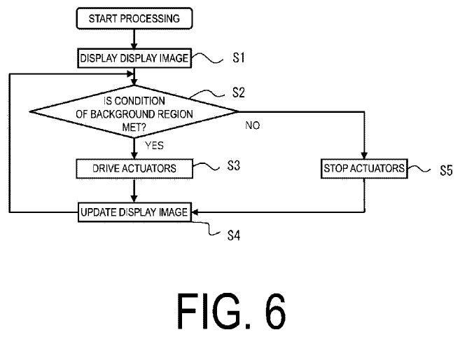

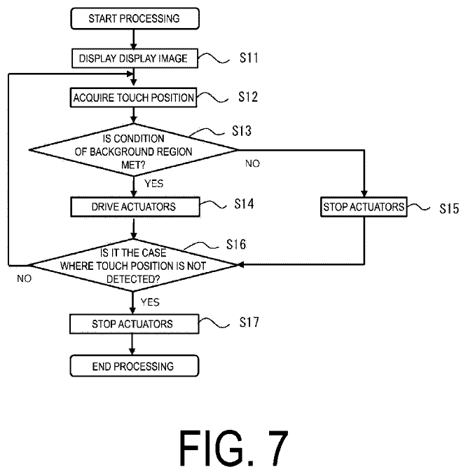

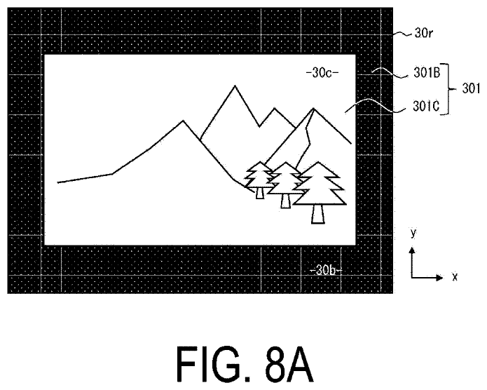

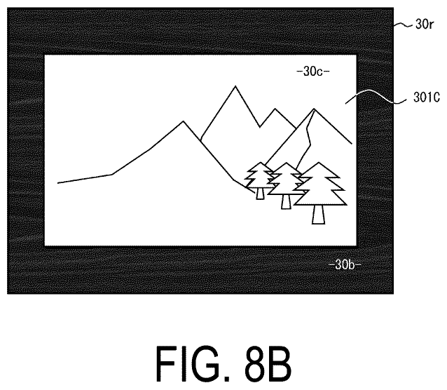

Next, the operation of the haptic touch panel display 101 will be described. FIG. 6 and FIG. 7 are flowcharts depicting control of the haptic touch panel display 101 according to a first display mode, and FIG. 8A and FIG. 8B illustrate examples of image data and a display exterior. In the first display mode, only a content image is displayed in the display region 30r. Before the haptic touch panel display 101 displays an image in the display region 30r, as illustrated in FIG. 2A, the design of the wood grain pattern that the light-transmitting decorative film 10 has is visually recognized from the outside in the display region 30r.

The control device 60 receives image data of a display image 301 illustrated in FIG. 8A from the outside, and outputs the image data to the display panel 30.

The display panel 30 displays the display image 301 in the display region 30r (S1). The display image 301 includes a content image 301C and a background image 301B, and the content image 301C and the background image 301B are respectively located in a content region 30c and a background region 30b of the display region 30r. In FIG. 8A, the background image 301B is illustrated by hatching, but the actual background image 301B is displayed in black with a gray scale value of zero or a predetermined low gray scale value.

As illustrated in FIG. 8B, in the content region 30c, light of the content image 301C is transmitted through the light-transmitting decorative film 10 disposed on the display panel 30, and thus the content image 301C is visually recognized from the outside. On the other hand, in the background region 30b, since the background image 301B is displayed in black, no light is transmitted or light is hardly transmitted. Thus, in the background region 30b, the design of the light-transmitting decorative film 10, that is, the wood grain pattern is visually recognized from the outside.

The control device 60 extracts a region having a gray scale value of zero or a predetermined value or less and a size larger than a predetermined size from the image data of the display image 301 (S2). For example, the region larger than the predetermined size is a region, in an x-axis direction, larger than a width of the content region 30c in the x-axis direction. By extracting the region under such a condition, the control device 60 can appropriately extract the background region 30b in which the background image 301B is arranged.

The control device 60 controls the haptic control circuit 50 to drive the actuators 40 such that the light-transmitting decorative film 10 vibrates with a texture represented by the design of the light-transmitting decorative film 10 in the extracted region, that is, the background region 30b (S3). The control device 60 controls the haptic control circuit 50 such that the light-transmitting decorative film 10 does not vibrate with the texture represented by the design of the light-transmitting decorative film 10 in the region other than the extracted region in the display region 30r, that is, in the content region 30c (S5). The control device 60 may control the haptic control circuit 50 such that the light-transmitting decorative film 10 does not vibrate in the content region 30c, or may control the haptic control circuit 50 such that the light-transmitting decorative film 10 vibrates with a texture different from the texture represented by the design of the light-transmitting decorative film 10.

The control device 60 receives next frame image data of the display image 301 from the outside, and outputs the next frame image data to the display panel 30. The display panel 30 updates the display image 301 to be displayed in the display region 30r (S4). Furthermore, the control device 60 repeats the above-described steps S2 to S4.

According to this control, when the content image 301C is displayed in the display region 30r, the light-transmitting decorative film 10 vibrates in the background region 30b regardless of the presence or absence of user touch. However, the control device 60 may cause the light-transmitting decorative film 10 to vibrate only when the user touches the light-transmitting decorative film 10.

As illustrated in FIG. 7, the control device 60 receives image data of the display image 301 illustrated in FIG. 8A from the outside, and outputs the image data to the display panel 30. The display panel 30 displays the display image 301 in the display region 30r (S11).

When the user touches the upper surface 10a of the light-transmitting decorative film 10 in the display region 30r of the haptic touch panel display 101, the control device 60 acquires a touch position (x, y) of the user from a detection signal received from the touch panel 20 (S12).

The control device 60 extracts, as the background region 30b, a region having a gray scale value of zero or a predetermined value or less and a size larger than a predetermined size from the image data of the display image 301, and determines whether or not the touch position is within the background region 30b (S13).

When the touch position is within the background region 30b, the control device 60 controls the haptic control circuit 50 such that the light-transmitting decorative film 10 vibrates with a texture represented by the design of the light-transmitting decorative film 10 in the background region 30b (S14).

When the touch position is not in the background region 30b, the touch position is in the content region 30c. In this case, the control device 60 controls the haptic control circuit 50 such that the light-transmitting decorative film 10 does not vibrate with the texture represented by the design of the light-transmitting decorative film 10 in the content region 30c (S15).

The control device 60 receives a detection signal from the touch panel 20 at a predetermined cycle. When a touch by the user is not detected from the detection signal (S16), the control device 60 controls the haptic control circuit 50 to stop the vibration of the light-transmitting decorative film 10 (S17). When a touch by the user is detected, the above-described steps S11 to S16 are repeated. Accordingly, while the touch position is detected in the background region 30b, the control device 60 can control the haptic control circuit 50 such that the light-transmitting decorative film 10 vibrates with the texture represented by the design of the light-transmitting decorative film 10 in the background region 30b.

As described above, according to the haptic touch panel display 101 of the present embodiment, in a state where no image is displayed, in other words, in a state where black display is performed on the entire display region, the design of the light-transmitting decorative film 10 is presented. Thus, the haptic touch panel display 101 is harmonized with the surrounding members and can present a good exterior, compared to a case where a black region of a display in a state where no image is displayed is presented. For example, when the haptic touch panel display 101 is disposed at the instrument panel 200 of the vehicle, the presence of the display is not recognized in a state where no image is displayed, and an exterior with a luxury feeling of a wood grain pattern can be presented.

On the other hand, when the content image is displayed on the haptic touch panel display 101, the content image is displayed through the light-transmitting decorative film 10. Thus, the design of the light-transmitting decorative film 10 is represented around the content image, and thus the content image can be displayed in a luxurious manner without the frame region of the display or the like being visually recognized.

Further, by using the display image data in which the periphery of the content image is constituted by the background image for black display, even when the size of the content image is changed, the periphery of the content image can be surrounded by the design of the light-transmitting decorative film 10. This does not cause a blank space to appear although a black space is often generated when an image that does not match the size of the display region is displayed.

Furthermore, in the region where the design of the light-transmitting decorative film 10 is presented, the texture of the design of the light-transmitting decorative film 10 can be obtained. Since the design of the light-transmitting decorative film 10 is recognized by the visual sensation and the haptic sensation, it is possible to present a feeling to the user as if an actual material represented by the design of the light-transmitting decorative film 10 is disposed around the content image.

In addition, since the texture represented by the design of the light-transmitting decorative film 10 is not obtained in the region where the content image is displayed, the occurrence of a sense of discomfort can be suppressed when the user touches the content image to perform an input operation. By using the display image data including the background image described above, even when the size of the content image is changed, the periphery of the content image can be surrounded by the design of the light-transmitting decorative film 10. Furthermore, the region where the content image is displayed is not provided with unevenness corresponding to the design of the light-transmitting decorative film 10, suppressing scatter and blur of the content image due to unevenness.

### (2) Second Display Mode

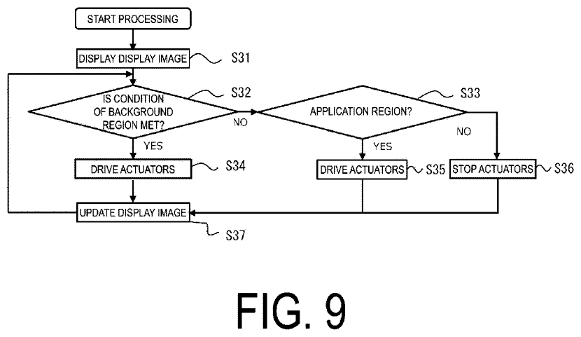

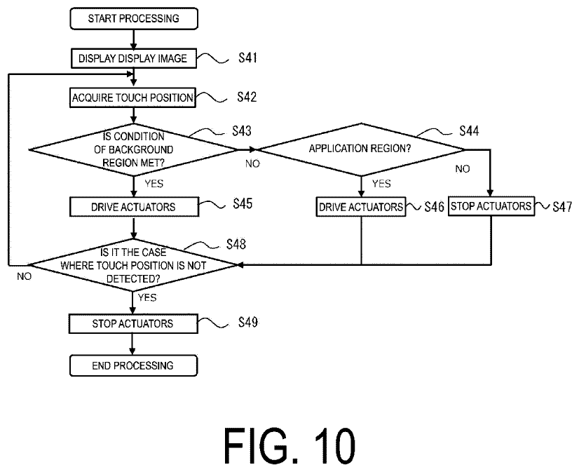

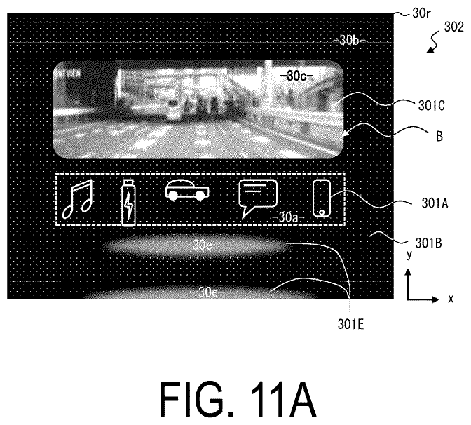

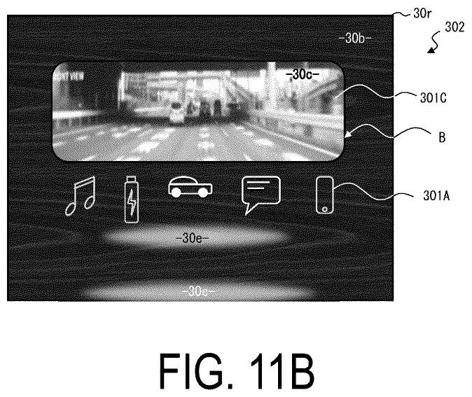

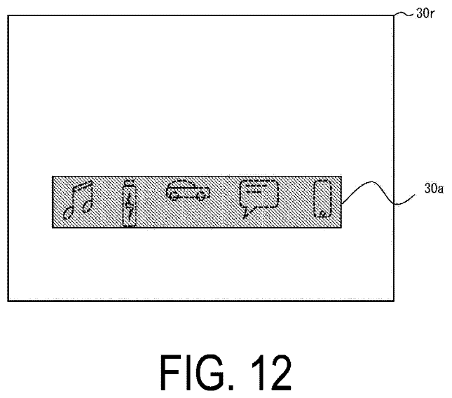

Next, an example of displaying a content image and icons on the haptic touch panel display 101 will be described. FIG. 9 and FIG. 10 are flowcharts when a content image and icons are displayed in the display region 30r of the haptic touch panel display 101, and each of FIG. 11A and FIG. 11B illustrates an example of image data and a display exterior according to a second display mode. FIG. 12 illustrates an example of an application region in the second display mode.

As in the first display mode, before the haptic touch panel display 101 displays an image in the display region 30r, as illustrated in FIG. 2A, the design of a wood grain pattern that the light-transmitting decorative film 10 has is visually recognized from the outside in the display region 30r.

The control device 60 receives image data of a display image 302 illustrated in FIG. 11A from the outside and outputs the image data to the display panel 30, and the display panel 30 displays the display image 302 in the display region 30r (S31). The display image 302 includes the content image 301C, the background image 301B, and the icon image 301A, and the content image 301C, the background image 301B, and the icon image 301A are respectively located in the content region 30c, the background region 30b, and an application region 30a of the display region 30r. As illustrated in FIG. 11B, the control device 60 stores position information of the application region 30a in the display region 30r.

Similarly to the first display mode, the background image 301B is displayed in black. Further, the icon image 301A includes a symbol related to a function to be executed when the user selects an icon by touching the icon. The symbol is drawn in, for example, white or a bright color with high brightness, and the background is displayed in, for example, black, which is the same as the background image 301B.

As illustrated in FIG. 11B, in the content region 30c, light of the content image 301C is transmitted through the light-transmitting decorative film 10 disposed on the display panel 30, and thus the content image 301C is visually recognized from the outside. In the background region 30b, the background image 301B is displayed in black, and thus the wood grain pattern that the light-transmitting decorative film 10 has is visually recognized.

In addition, in the application region 30a, the symbol of the icon image 301A is drawn in white or a bright color. The wood grain pattern continuous with the background region 30b is visually recognized as the background of the application region 30a.

The control device 60 extracts a region having a gray scale value of zero or a predetermined value or less and a size larger than a predetermined size from the image data of the display image 302 (S32). For example, as in the first display mode, the region larger than the predetermined size is a region, in the x-axis direction, larger than a width of the content region 30c in the x-axis direction. Accordingly, the control device 60 can appropriately extract the background region 30b in which the background image 301B is disposed.

The control device 60 controls the haptic control circuit 50 such that the light-transmitting decorative film 10 vibrates with a texture represented by the design of the light-transmitting decorative film 10 in the extracted region, that is, the background region 30b (S34).

The control device 60 extracts the application region 30a from the region other than the extracted background region 30b in the display region 30r (S33), and controls the haptic control circuit 50 such that the light-transmitting decorative film 10 vibrates with a texture different from the texture represented by the design of the light-transmitting decorative film 10 (S35). Furthermore, the haptic control circuit 50 is controlled such that the light-transmitting decorative film 10 does not vibrate in a region other than the application region 30a, that is, in the content region 30c (S36).

The control device 60 receives next frame image data of the display image 302 from the outside, and outputs the next frame image data to the display panel 30. The display panel 30 updates the display image 302 to be displayed in the display region 30r (S37). Further, the control device 60 repeats the above-described steps S32 to S36.

In a case where the light-transmitting decorative film 10 is vibrated only when the user touches the light-transmitting decorative film 10, the control device 60 controls the haptic touch panel display 101 in accordance with the flowchart depicted in FIG. 10.

Specifically, first, the control device 60 receives image data of the display image 302 illustrated in FIG. 11A from the outside, and outputs the image data to the display panel 30. The display panel 30 displays the display image 302 in the display region 30r (S41).

When the user touches the upper surface 10a of the light-transmitting decorative film 10 in the display region 30r of the haptic touch panel display 101, the control device 60 acquires a touch position (x, y) of the user from a detection signal received from the touch panel 20 (S42).

The control device 60 extracts, as the background region 30b, a region having a gray scale value of zero or a predetermined value or less and a size larger than a predetermined size from the image data of the display image 302, and determines whether or not the touch position is within the background region 30b (S43).

When the touch position is within the background region 30b, the control device 60 controls the haptic control circuit 50 to drive the actuators 40 such that the light-transmitting decorative film 10 vibrates with a texture represented by the design of the light-transmitting decorative film 10 in the background region 30b (S45).

When the touch position is within the application region 30a, the control device 60 controls the haptic control circuit 50 to drive the actuators 40 such that the light-transmitting decorative film 10 vibrates with a texture different from the texture represented by the design of the light-transmitting decorative film 10 in the application region 30a (S46).

Further, when the touch position is in a region other than the background region 30b and the application region 30a, that is, in the content region 30c, the haptic control circuit 50 is controlled such that the light-transmitting decorative film 10 does not vibrate, and thus the actuators are stopped (S47).

The control device 60 receives a detection signal from the touch panel 20 at a predetermined cycle. When a touch by the user is not detected from the detection signal (YES in S48), the control device 60 controls the haptic control circuit 50 to stop the vibration of the light-transmitting decorative film 10 (S49). When a touch by the user is detected (NO in S48), the above-described steps S42 to S48 are repeated. That is, when the touch position is within the background region 30b, the control device 60 vibrates the light-transmitting decorative film 10 with the texture represented by the design of the light-transmitting decorative film 10 in the background region 30b, and when the touch position is within the application region 30a, the control device 60 vibrates the light-transmitting decorative film 10 with a texture different from the texture represented by the design of the light-transmitting decorative film 10 in the application region 30a. In addition, when the touch position is within the content region 30c, the control device 60 does not vibrate the light-transmitting decorative film 10 in the content region 30c.

According to the second display mode, when an icon is displayed in the display region 30r, the light-transmitting decorative film 10 vibrates with a texture different from the texture represented by the design of the light-transmitting decorative film 10 in the icon region. Thus, the user can recognize that the user has touched the icon, and can obtain an excellent feeling of operation.

### (3) Different Haptic Effect 1

The haptic touch panel display 101 may present a haptic effect other than the above-described haptic effects to the user.

For example, in the display image 302 illustrated in FIG. 11B, the background image may be set such that the wood grain pattern of the light-transmitting decorative film 10 illustrated in the background region 30b has a shade, and the intensity of the vibration of the light-transmitting decorative film 10 may be changed according to the shade of the wood grain pattern. To be more specific, as illustrated in FIG. 11B, a display effect region 30e is arranged in the wood grain pattern represented in the background region 30b. The display effect region 30e has the central portion being bright and having a light wood grain pattern and becomes darker toward the outside while the wood grain pattern becomes darker. For example, arranging such a display effect region 30e makes it possible to obtain an effect that the icon image 301A located above the display effect region 30e appears to be raised.

In order to perform such a display, for example, as illustrated in FIG. 11A, data of a display image 302 is prepared in which a display effect image 301E having a gray scale value being high at the center and gray scale values decreasing toward the periphery is arranged in the background image 301B.

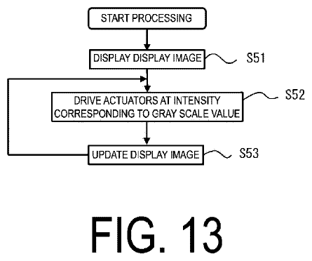

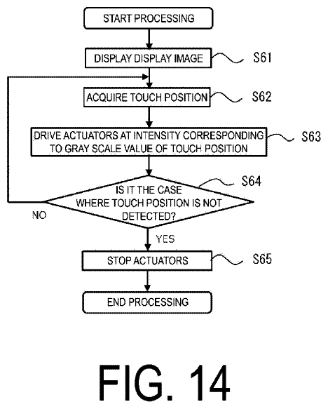

FIG. 13 and FIG. 14 are flowcharts depicting control of the haptic touch panel display 101 when the display effect region 30e is displayed in the display region 30r of the haptic touch panel display 101.

The control device 60 receives image data of the display image 302 illustrated in FIG. 11A from the outside and outputs the image data to the display panel 30, and the display panel 30 displays the display image 302 in the display region 30r (S51). Accordingly, the content image 301C and the icon image 301A illustrated in FIG. 11A are displayed in the display region 30r, and the wood grain pattern in which the display effect region 30e is bright is represented in the background region 30b.

The control device 60 controls the haptic control circuit 50 such that the vibration intensity changes in the background region 30b according to a distribution of the gray scale values of the background image 301B. In detail, the control device 60 extracts the background region 30b from the display region 30r, divides the background region 30b into meshes with an appropriate size, and calculates the average gray scale value in the divided meshes, as in the first display mode. Further, the control device 60 controls the haptic control circuit 50 such that the light-transmitting decorative film 10 vibrates at the intensity corresponding to the calculated average gray scale value at the coordinates of each division (S52). For example, the vibration intensity is increased when the average gray scale value is small, and the vibration intensity is decreased when the average gray scale value is large.

The control device 60 receives next frame image data of the display image 302 from the outside, and outputs the next frame image data to the display panel 30. The display panel 30 updates the display image 302 to be displayed in the display region 30r (S53). Further, the control device 60 repeats the above-described steps S51 to S53.

In a case where the light-transmitting decorative film 10 is vibrated only when the user touches the light-transmitting decorative film 10, the control device 60 controls the haptic touch panel display 101 in accordance with the flowchart depicted in FIG. 14.

First, the control device 60 receives image data of the display image 302 illustrated in FIG. 11A from the outside, and outputs the image data to the display panel 30. The display panel 30 displays the display image 302 in the display region 30r (S61).

When the user touches the upper surface 10a of the light-transmitting decorative film 10 in the display region 30r of the haptic touch panel display 101, the control device 60 acquires a touch position (x, y) of the user from a detection signal received from the touch panel 20 (S62).

When the touch position is within the background region 30b, the control device 60 controls the haptic control circuit 50 such that the light-transmitting decorative film 10 vibrates at the intensity corresponding to the gray scale value of the touch position (S63). Specifically, for example, the vibration intensity is increased when the gray scale value is small, and the vibration intensity is decreased when the gray scale value is large.

The control device 60 receives a detection signal from the touch panel 20 at a predetermined cycle. When a touch by the user is not detected from the detection signal (S64), the control device 60 controls the haptic control circuit 50 to stop the vibration of the light-transmitting decorative film 10 (S65). When a touch by the user is detected, the above-described steps S61 to S64 are repeated.

Such control allows the user to obtain the texture that matches the visual effect. As a result, the user can obtain an excellent feeling of operation.

### (4) Different Haptic Effect 2

The haptic touch panel display 101 may present, to the user, an effect of assisting a touch input by the user. For example, in the display image 302 illustrated in each of FIG. 11A and FIG. 11B, when the touch position of the user moves beyond a boundary B between the background region 30b and the content region 30c, a texture for notifying the user of the fact that the touch position has moved to a different region may be presented.

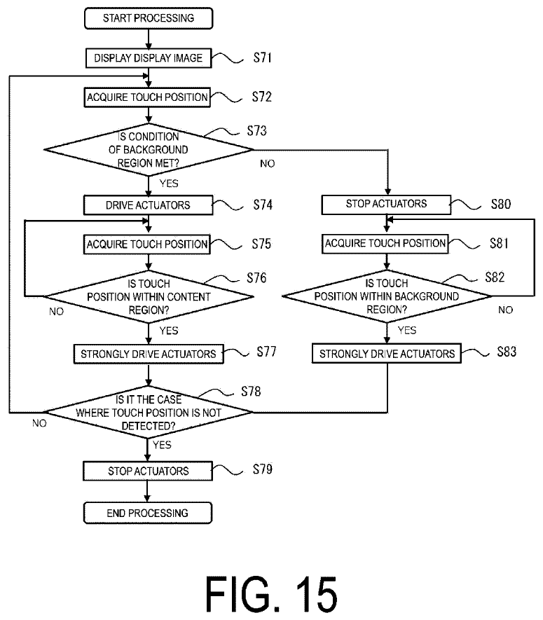

FIG. 15 is a flowchart depicting control of the haptic touch panel display 101 when such notification is performed.

First, the control device 60 receives image data of the display image 302 illustrated in FIG. 11A from the outside, and outputs the image data to the display panel 30. The display panel 30 displays the display image 302 in the display region 30r (S71).

When the user touches the upper surface 10a of the light-transmitting decorative film 10 in the display region 30r of the haptic touch panel display 101, the control device 60 acquires a touch position (x, y) of the user from a detection signal received from the touch panel 20 (S72).

The control device 60 determines whether the touch position is within (a) the background region 30b or (b) a region other than the background region 30b and other than the application region 30a, that is, the content region 30c (S73).

When the touch position is within the background region 30b, the control device 60 controls the haptic control circuit 50 such that the light-transmitting decorative film 10 vibrates with a texture represented by the design of the light-transmitting decorative film 10 in the background region 30b (S74).

The control device receives a detection signal from the touch panel 20 at a predetermined cycle (S75), and determines whether the detected position is within the content region 30c (S76). When the detected position is not within the content region 30c, steps S75 and S76 are repeated.

Whether or not the touch position is within the content region 30c is determined (S76). When the touch position is not within the content region 30c, steps S75 and S76 are repeated.

When the touch position is within the content region 30c, the touch position moves beyond a boundary between the background region 30b and the content region 30c. In this case, the control device 60 controls the haptic control circuit 50 such that the light-transmitting decorative film 10 more largely vibrates at the touch position in the content region 30c, which is a region after the movement (S77). The vibration at this time is larger than the vibration in step S74.

The control device 60 receives a detection signal from the touch panel 20 at a predetermined cycle. When a touch by the user is not detected from the detection signal (S78), the control device 60 controls the haptic control circuit 50 to stop the vibration of the light-transmitting decorative film 10 (S79). When a touch by the user is detected, the above-described steps S71 to S78 are repeated.

In addition, in step S73, when the touch position is within the content region 30c, the control device 60 controls the haptic control circuit 50 such that the light-transmitting decorative film 10 does not vibrate (S80).

The control device 60 receives a detection signal from the touch panel 20 at a predetermined cycle (S81), and determines whether or not the detected position is within the background region 30b (S82). When the detected position is not within the background region 30b, steps S81 and S82 are repeated.

When the touch position is within the background region 30b, the touch position has moved beyond the boundary between the content region 30c and the background region 30b. In this case, the control device 60 controls the haptic control circuit 50 such that the light-transmitting decorative film 10 more largely vibrates at the touch position in the background region 30b, which is a region after the movement (S83). The vibration here is larger than the vibration in step S74.

In this manner, when the touch position moves beyond the boundary between the content region 30c and the background region 30b, the control device 60 controls the haptic control circuit 50 such that the light-transmitting decorative film 10 more largely vibrates than the vibration of the light-transmitting decorative film 10 in step S74 at the touch position in the region after the movement.

The control device 60 receives a detection signal from the touch panel 20 at a predetermined cycle. When a touch by the user is not detected from the detection signal (S78), the control device 60 controls the haptic control circuit 50 to stop the vibration of the light-transmitting decorative film 10 (S79). When a touch by the user is detected, the above-described S71 to S78 are repeated.

According to such control, when the user moves the touch position between the background region 30b and the content region 30c, the user can more clearly recognize, by the haptic sensation, that the touch region is moved. Thus, the haptic touch panel display 101 can present more excellent operability to the user.

Note that although the case where the touch position is moved between the background region 30b and the content region 30c has been described above, the above-described control may be performed also in a case where the touch position is moved between the background region 30b and the application region 30a. Moreover, the intensity of the vibration in step S77 and the intensity of the vibration in step S83 may be the same or different.

In addition, in the above-described embodiment, the movement to a different region is detected by using a change of the touch position, and the haptic control circuit 50 is controlled such that the light-transmitting decorative film 10 more largely vibrates, but the light-transmitting decorative film 10 may be configured to more largely vibrate by another control method. For example, a belt-shaped boundary region including the boundary between the background region 30b and the content region 30c may be provided, and the light-transmitting decorative film 10 may be more largely vibrated when the touch position is within the boundary region.

### Second Embodiment

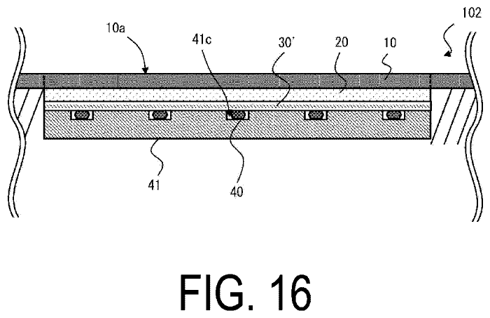

FIG. 16 is a schematic cross-sectional view of a haptic touch panel display 102 according to the present embodiment. The haptic touch panel display 102 is different from that of the first embodiment in that a display panel 30′ is a self-luminous panel. Specifically, the display panel 30′ is a self-luminous panel such as an organic EL panel or a micro LED panel. Since the display panel 30′ is the self-luminous panel, the thickness of the display panel 30′ can be reduced as compared with a case of a liquid crystal panel. This allows the vibration of the actuators 40 disposed on the back face to be transmitted to the light-transmitting decorative film 10 with larger vibration.

### Third Embodiment

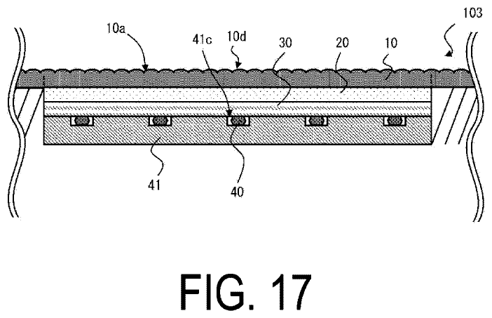

FIG. 17 is a schematic cross-sectional view of a haptic touch panel display 103 according to the present embodiment. The haptic touch panel display 103 is different from that of the first embodiment in that the light-transmitting decorative film 10 has unevenness 10d on the upper surface 10a.

The unevenness 10d preferably has a shape corresponding to the design of the light-transmitting decorative film 10. When the design of the light-transmitting decorative film 10 has wood grain, the unevenness 10d also includes unevenness distributed in a shape corresponding to the design of the wood grain. In addition, preferably, the unevenness 10d does not significantly deteriorate display characteristics of the haptic touch panel display 103 according to the present embodiment. In particular, it is preferable that the height of the unevenness 10d be set to be small to such an extent that an image displayed in the display region 30r is not blurred or smudged.

When the haptic control circuit 50 vibrates the actuators 40, the haptic control circuit 50 drives the actuators 40 such that the unevenness 10d can be more strongly tactual in the background region 30b. Further, in the content region 30c, the actuators 40 are driven such that the unevenness 10d is less likely to be tactual.

By providing the unevenness 10d on the upper surface 10a of the light-transmitting decorative film 10 in this manner, the user can be caused to more strongly feel the texture of the design that the light-transmitting decorative film 10 has. Thus, even when the light-transmitting decorative film 10 is made of resin or the like, the user can obtain the visual sensation and the haptic sensation as if the light-transmitting decorative film 10 is made of a real material.

### OTHER EMBODIMENTS

The haptic touch panel display according to the disclosure is not limited to the above-described embodiments, and can be modified in various ways. For example, the haptic touch panel displays according to the second and third embodiments may implement the display mode and the display effect described in the first embodiment. Further, the control method of the haptic touch panel display described in each embodiment is not limited to the procedure depicted in the flowchart referred to in each embodiment, and may be performed by another procedure.

Furthermore, the number and arrangement of the actuators 40 and the structure of the support body 41 supporting the actuators 40 are not limited to those in the above-described embodiments. A partition or the like for suppressing vibration may be provided between the plurality of actuators 40.

The haptic touch panel display according to the disclosure can be also described as follows.

A haptic touch panel display according to a first configuration includes:
a display panel including a display region;
a touch panel disposed, in the display region, on an upper surface of the display panel or in the display panel;
a plurality of actuators configured to vibrate the display panel;
a light-transmitting decorative film supported in the display region of the display panel;
a haptic control circuit configured to drive the plurality of actuators and thus cause at least a part of the light-transmitting decorative film to vibrate with a first texture represented by an exterior of the light-transmitting decorative film; and
a control device configured to control the display panel, the touch panel, and the haptic control circuit.

According to the first configuration, in a state where an image is not displayed, the design of the light-transmitting decorative film is presented. This allows the haptic touch panel display to be harmonized with the surrounding members and to present the good exterior, compared to a case where the black region of a display in an OFF state is presented. In addition, in the region where the design of the light-transmitting decorative film is presented, the texture of the design of the light-transmitting decorative film is obtained, making it possible to present a feeling to the user as if an actual material represented by the design of the light-transmitting decorative film is arranged around a content image.

In a haptic touch panel display according to a second configuration, in the first configuration, the display panel may display a content image in a part of the display region, the light-transmitting decorative film may transmit the content image, and the control device may cause the haptic control circuit to drive the plurality of actuators and thus cause the light-transmitting decorative film not to vibrate with the first texture in a content region in which the content image is displayed.

In a haptic touch panel display according to a third configuration, in the second configuration, the control device may receive, from the outside, data of a display image including the content image, the display image being subject to display in the display region, and output the data to the display panel, detect, from the display image, a background region in which a background image having a gray scale value equal to or less than a predetermined value and having a size larger than a predetermined size is located, and control the haptic control circuit and thus cause the light-transmitting decorative film to vibrate with the first texture in the background region.

In a haptic touch panel display according to a fourth configuration, in the third configuration, the control device may control the haptic control circuit and thus cause an intensity of the vibration to be changed according to a distribution of the gray scale value of the background image in the background region.

In a haptic touch panel display according to a fifth configuration, in the fourth configuration, the display image may include an image of an icon indicating an operation on the haptic touch panel display, and the control device may control the haptic control circuit and thus cause the light-transmitting decorative film to vibrate with a second texture different from the first texture in an application region in which the icon is arranged in the display region.

In a haptic touch panel display according to a sixth configuration, in the third configuration, the touch panel may transmit a detection signal to the control device at a predetermined cycle, and the control device may acquire a touch position from the detection signal, and control the haptic control circuit and thus cause the light-transmitting decorative film to vibrate with the first texture in the background region while the touch position is being detected in the background region.

In a haptic touch panel display according to a seventh configuration, in the third configuration, the touch panel may transmit a detection signal to the control device at a predetermined cycle, and the control device may acquire a touch position from the detection signal, and control the haptic control circuit and thus, when the touch position is moved beyond a boundary between the content region and the background region, cause the light-transmitting decorative film to more largely vibrate at the touch position in a region after the movement than the vibration of the light-transmitting decorative film in the background region.

In a haptic touch panel display according to an eighth configuration, in the third configuration, the light-transmitting decorative film may include unevenness on a surface of the light-transmitting decorative film, and the control device may control the haptic control circuit and thus cause the unevenness to emphasize the first texture.

In a haptic touch panel display according to a ninth configuration, in any one of the first to eighth configurations, the display panel may be a liquid crystal display panel.

In a haptic touch panel display according to a tenth configuration, in any one of the first to eighth configurations, the display panel may be a self-luminous panel.

A vehicle according to an eleventh configuration includes:
the haptic touch panel display according to any one of the first to eighth configurations; and
an instrument panel provided with a light-transmitting decorative film on a surface of the instrument panel, the instrument panel being disposed with the haptic touch panel display, in which the light-transmitting decorative film of the instrument panel and the light-transmitting decorative film of the haptic touch panel display are integrally continuous.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A haptic touch panel display comprising:
a display panel including a display region;
a touch panel disposed, in the display region, on an upper surface of the display panel or in the display panel;
a plurality of actuators configured to vibrate the display panel;
a light-transmitting decorative film supported in the display region of the display panel;
a haptic control circuit configured to drive the plurality of actuators and thus cause at least a part of the light-transmitting decorative film to vibrate with a first texture represented by an exterior of the light-transmitting decorative film; and
a control device configured to control the display panel, the touch panel, and the haptic control circuit.

2. The haptic touch panel display according to claim 1,
wherein the display panel displays a content image in a part of the display region,
the light-transmitting decorative film transmits the content image, and
the control device causes the haptic control circuit to drive the plurality of actuators and thus causes the light-transmitting decorative film not to vibrate with the first texture in a content region in which the content image is displayed.

3. The haptic touch panel display according to claim 2,
wherein the control device
receives, from the outside, data of a display image including the content image, the display image being subject to display in the display region, and outputs the data to the display panel,
detects, from the display image, a background region in which a background image having a gray scale value equal to or less than a predetermined value and having a size larger than a predetermined size is located, and
controls the haptic control circuit and thus causes the light-transmitting decorative film to vibrate with the first texture in the background region.

4. The haptic touch panel display according to claim 3,
wherein the control device controls the haptic control circuit and thus causes an intensity of the vibration to be changed according to a distribution of the gray scale value of the background image in the background region.

5. The haptic touch panel display according to claim 4,
wherein the display image includes an image of an icon indicating an operation on the haptic touch panel display, and
the control device controls the haptic control circuit and thus causes the light-transmitting decorative film to vibrate with a second texture different from the first texture in an application region in which the icon is arranged in the display region.

6. The haptic touch panel display according to claim 3,
wherein the touch panel transmits a detection signal to the control device at a predetermined cycle, and
the control device
acquires a touch position from the detection signal, and
controls the haptic control circuit and thus causes the light-transmitting decorative film to vibrate with the first texture in the background region while the touch position is being detected in the background region.

7. The haptic touch panel display according to claim 3,
wherein the touch panel transmits a detection signal to the control device at a predetermined cycle, and
the control device
acquires a touch position from the detection signal, and
controls the haptic control circuit and thus, when the touch position is moved beyond a boundary between the content region and the background region, causes the light-transmitting decorative film to more largely vibrate at the touch position in a region after the movement than the vibration of the light-transmitting decorative film in the background region.

8. The haptic touch panel display according to claim 3,
wherein the light-transmitting decorative film includes unevenness on a surface of the light-transmitting decorative film, and
the control device controls the haptic control circuit and thus causes the unevenness to emphasize the first texture.

9. The haptic touch panel display according to claim 1,
wherein the display panel is a liquid crystal display panel.

10. The haptic touch panel display according to claim 1,
wherein the display panel is a self-luminous panel.
